(19) United States
(12) Patent Application Publication
(10) Pub. No.: US 2016/0295515 A1
(43) Pub. Date: Oct. 6, 2016

(54) Using Mobile Unit Battery Level And Drain Rate To Control Handover

(71) Applicant: Alcatel-Lucent USA Inc., Murray Hill, NJ (US)

(72) Inventors: Yigang Cai, Naperville, IL (US); Anil Rao, Redmond, WA (US)

(73) Assignee: Alcatel-Lucent USA Inc., Murray Hill, NJ (US)

(21) Appl. No.: 14/672,317

(22) Filed: Mar. 30, 2015

(51) Int. Cl. H04W 52/02; H04W 36/26; H04W 36/00

(52) U.S. Cl. CPC H04W 52/0261; H04W 36/0088; H04W 36/26; H04W 88/08

(57) ABSTRACT

A base station determines whether a mobile unit should handoff based upon the battery level and battery drain of the mobile unit battery. The battery level and battery drain are sent from the mobile unit to the base station. The base station uses this information to determine whether the mobile unit should power up or power down LTE-U or WiFi radio connections and services. In addition, this information allows the base station to determine whether the mobile unit should handoff between LTE-L and LTE-U base stations, in order to control power consumption of the mobile unit and prolong the battery life of the mobile unit.

### FIELD OF THE INVENTION

The present invention relates generally to communication systems.

### BACKGROUND OF THE INVENTION

A battery in a mobile device carries a charge. The battery charge and drain rate are currently measurable at some mobile devices. However, this information is typically not known by network elements.

Handing off to other base stations consumes more mobile unit battery power than remaining at a current base station due to the powering up of multiple radios. Multiple handoffs of a mobile unit with low battery power can consume enough power of the mobile unit that the mobile unit runs out of battery power and will not be functional until the battery is recharged or replaced.

Therefore, a need exists for a way to allow handoffs of mobile units without consuming too much power from the battery of the mobile unit.

### BRIEF SUMMARY OF THE INVENTION

An exemplary embodiment of the present invention provides for a determination of whether a mobile unit should handoff based upon the battery level and battery drain of the mobile unit battery. The battery level and battery drain are sent from the mobile unit to a base station. The base station uses this information to determine whether the mobile unit should power up or power down LTE-U and/or WiFi radio connections/services. In addition, this information allows the base station to determine whether the mobile unit should handoff between LTE-L and LTE-U base stations, in order to control power consumption of the mobile unit and prolong the battery life of the mobile unit.

The base station preferably calculates the transmitting power for LTE-L/LTE-U per channel/path and compares this required power level with the status of the battery level and battery drain rate of the mobile unit, with different level thresholds, to control the power and battery life for the mobile unit.

In addition, with power control calculations, the base station is developed with new methods and able to mute some cells, such as LTE-L and LTE-U base stations, using coordinated scheduling, in order to prolong the battery life of the mobile unit.

### BRIEF DESCRIPTION OF THE SEVERAL VIEWS OF THE DRAWINGS

FIG. 1 depicts the functional architecture of a communication network in accordance with an exemplary embodiment of the present invention.

FIG. 2 depicts a call flow diagram in accordance with an exemplary embodiment of the present invention.

### DETAILED DESCRIPTION OF THE INVENTION

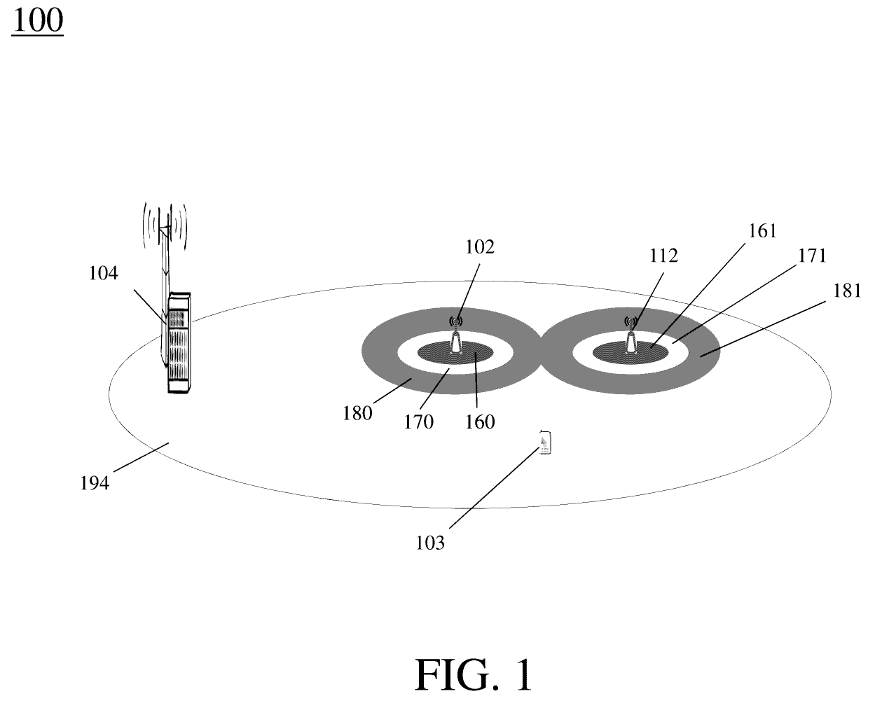

FIG. 1 depicts the functional architecture of a wireless communication network 100 in accordance with an exemplary embodiment of the present invention. Communication network 100 preferably includes base station 104, Metro eNBs 102 and 112, and mobile unit 103. It should be understood that additional network elements can be included in communication network 100, but only these elements are depicted for clarity.

Wireless network 100 is a wireless communication network that provides subscribers the ability to place and receive calls to other communication units. Network 100 can utilize any wireless network protocol, including but not limited to 3G, WCDMA, CDMA2000, LTE and WiMAX.

In accordance with an exemplary embodiment, wireless network 100 authorizes carrier grade WiFi. Carrier grade WiFi can preferably belong to any third parties equipped with carrier grade functions. In accordance with an exemplary embodiment, wireless network 100 sets the priority of authorized WiFi which are in the vicinity of multiple small cells or macro cells.

In accordance with an exemplary embodiment, wireless network 100 provisions a list of authorized WiFi candidate cells into a handover candidate list. The cells can be small cells, macrocells, or both. The list can be static or dynamic. Small cells preferably know the coverage and transmit power strength of WiFi transmitters in the list. In LTE systems, small cells can shift data service to authorized WiFi for LTE service.

Base station 104 is preferably a macro Evolved Node B (eNodeB or eNB). Base station 104 provides radio coverage within a macrocell 194 using licensed spectrum. Base station 104 is a wireless base station that communicates with mobile units within macrocell 194 and connects the mobile units to the land-line network for call completion. Base station 104 preferably includes a receiver, a transmitter, a processor, and memory.

Metro eNBs 102 and 112 each comprise a small, low-power cellular base station. Metro eNBs can alternately be referred to as small cells.

In an exemplary embodiment, carrier grade WiFi is integrated within metro eNBs 102 and 112. Alternately, carrier grade WiFi is standalone and co-located with metro eNBs 102 and 112.

In accordance with the exemplary embodiment, metro eNBs 102 and 112 each include three coverage areas: a carrier-grade WiFi coverage area, a metro LTE eNB unlicensed carrier coverage area, and a metro LTE eNB licensed carrier coverage area. In the exemplary embodiment depicted in FIG. 1, metro eNB 102 includes carrier-grade WiFi coverage area 160, metro LTE eNB unlicensed carrier coverage area 170, and metro LTE eNB licensed carrier coverage area 180. In the exemplary embodiment depicted in FIG. 1, metro eNB 112 includes carrier-grade WiFi coverage area 161, metro LTE eNB unlicensed carrier coverage area 171, and metro LTE eNB licensed carrier coverage area 181.

Mobile unit 103 includes an interface, a receiver, a transmitter, a processor, and memory. In the exemplary embodiment depicted in FIG. 1, mobile unit 103 is located in coverage area 194 and served by macro eNB 104.

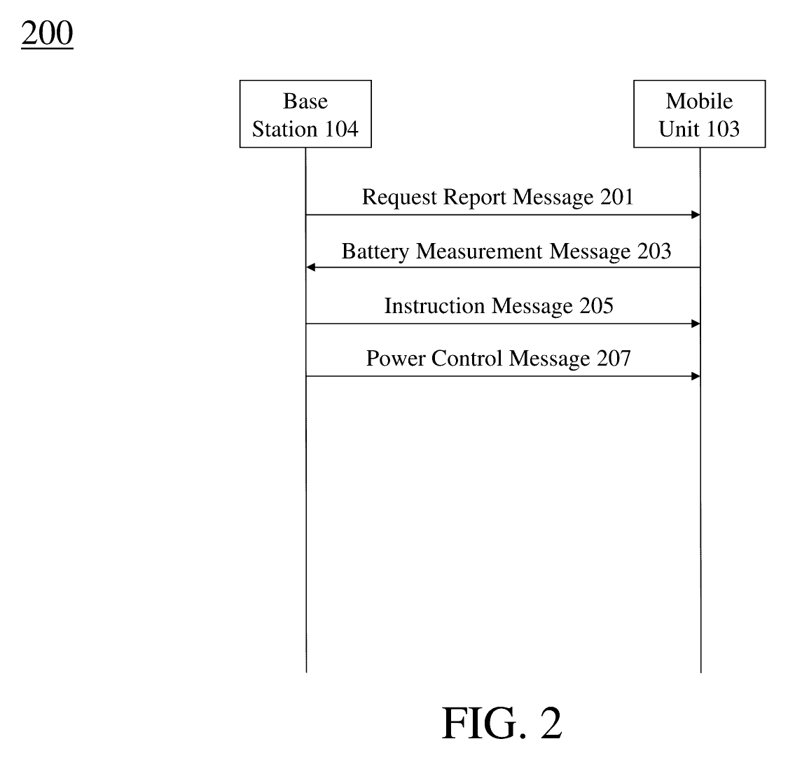

FIG. 2 depicts a call flow diagram 200 in accordance with an exemplary embodiment of the present invention. Carrier grade WiFi access points (APs) commonly charge lower rates for wireless data usage. An exemplary embodiment determines whether a mobile unit has sufficient battery power to make a handoff to an LTE-U base station or a WiFi access point logical. If so, the mobile unit is handed over to the LTE-U base station or the WiFi AP.

In accordance with an exemplary embodiment, base station 104 sends Request Report Message 201 to mobile unit 103. Request Report Message 201 is a request for mobile unit 103 to report the battery level and the drain rate of the battery in mobile unit 103. In accordance with an exemplary embodiment, base station 104 sets a time window and report interval, with a timer or the like.

Mobile unit 103 sends Battery Measurement Message 203 to base station 104 in response to Request Report Message 201. Battery Measurement Message 203 preferably includes the current battery level and drain rate of mobile unit 103. Base station 104 retrieves the battery level and drain rate from Battery Measurement Message 203.

In accordance with an exemplary embodiment, base station 104 utilizes the battery level and drain rate to analyze the status and trend of battery usage of mobile unit 103. Base station 104 preferably determines a threshold value at which base station 104 will instruct mobile unit 103 to disable LTE-U and WiFi connections. In addition, base station 104 can utilize the threshold value to determine whether to instruct mobile unit 103 whether mobile unit 103 should handoff between LTE-L and LTE-U base stations.

In accordance with an exemplary embodiment, base station 104 can utilize any combination of battery status and additional characteristics to determine the threshold value. Battery status preferably includes the battery level and the drain rate of the battery in the mobile unit. Additional characteristics preferably include required transmitting power, signal-to-noise ratio, and smart charging.

Base station 104 sends Instruction Message 205 to mobile unit 103. Instruction Message 205 preferably includes an enable LTE-U flag and an enable WiFi flag. If the enable LTE-U flag is set to Yes, it indicates that base station 104 wants to instruct mobile unit 103 to enable LTE-U connections and service, and if the enable LTE-U flag is set to No, it indicates that base station 104 wants to instruct mobile unit 103 to disable LTE-U connections and services. If the enable WiFi flag is set to Yes, it indicates that base station 104 wants to instruct mobile unit 103 to enable WiFi connections and service, and if the enable WiFi flag is set to No, it indicates that base station 104 wants to instruct mobile unit 103 to disable WiFi connections and services.

Mobile unit 103 receives Instruction Message 205. In accordance with an exemplary embodiment, if the enable LTE-U flag is set to Yes, mobile unit 103 enables LTE-U radio service. If the enable LTE-U flag is set to No, mobile unit 103 disables LTE-U radio service. In accordance with an exemplary embodiment, if the enable WiFi flag is set to Yes, mobile unit 103 enables WiFi radio connections and services. If the enable WiFi flag is set to No, mobile unit 103 disables WiFi radio connections and services. In accordance with an exemplary embodiment, mobile unit 103 notifies the user of mobile unit 103 with the battery level status and enabling or disabling of LTE-U and WiFi services.

In addition, base station 104 preferably utilizes the threshold to determine whether mobile unit 103 has sufficient battery power to handoff to an LTE-L or LTE-U base station. In an exemplary embodiment, if a WiFi connection requires higher transmitting power and the battery level of mobile unit 103 is under a threshold level, base station 104 will instruct mobile unit 103 not to handover to the WiFi connection regardless of the status of the WiFi connection, such as the WiFi connection providing superior signaling, greater coverage area, or charges a lower tariff.

In accordance with an exemplary embodiment, total transmitting power of mobile unit 103 is calculated per all of LTE-L, LTE-U and WiFi channels. Each channel path loss is preferably calculated individually. Each channel transmitting power is a summation of nominal power, which is a function of target SINR and interference level, and path loss, which may consider the fractional power control (FPC).

Base station 104 sends power control value message 207 to mobile unit 103. Power control value message 207 preferably includes the power control value for each channel or path available, such as the LTE-L paths, the LTE-U paths, and the WiFi paths.

While this invention has been described in terms of certain examples thereof, it is not intended that it be limited to the above description, but rather only to the extent set forth in the claims that follow.

We claim:

1. A base station comprising:
a transmitter effective in sending a request report message to a mobile unit, the request report message including a request for the mobile unit to report the battery level and the drain rate of a battery in the mobile unit;
a receiver effective in receiving a battery measurement message in response to the request report message, the battery measurement message including the battery level and the drain rate of the battery in the mobile unit; and
a processor that analyzes the battery level and the drain rate to determine whether the mobile unit has sufficient battery power to perform predetermined functions.

2. A base station in accordance with claim 1, wherein the processor further sets a time window and report interval, and wherein the transmitter is effective in sending the request report message in response to the time window and report interval.

3. A base station in accordance with claim 1, wherein the processor determines whether the mobile unit has sufficient battery power to perform a predetermined function by comparing the battery power to a threshold value.

4. A base station in accordance with claim 3, wherein the predetermined function is a handoff of the mobile unit to a second base station.

5. A base station in accordance with claim 3, wherein the predetermined function is a handoff of the mobile unit to an LTE-U base station.

6. A base station in accordance with claim 1, wherein the transmitter is effective in sending an instruction message to the mobile unit, the instruction message including a flag for instructing the mobile unit whether to enable a connection at the mobile unit, and wherein the flag is based at least in part upon whether the mobile unit has sufficient battery power.

7. A base station in accordance with claim 1, wherein the transmitter is effective in sending an instruction message to the mobile unit, the instruction message including a flag for instructing the mobile unit whether to mute a cell, and wherein the flag is based at least in part upon whether the mobile unit has sufficient battery power.

8. A base station comprising:
a transmitter effective in sending a request report message to a mobile unit, the request report message including a request for the mobile unit to report the battery status of a battery in the mobile unit, the battery status comprising the battery level and the drain rate of the battery;
a receiver effective in receiving a battery measurement message in response to the request report message, the battery measurement message including the battery status of the battery in the mobile unit; and
a processor that analyzes the battery status and additional characteristics to determine whether the mobile unit has sufficient battery power to perform predetermined functions.

9. A base station in accordance with claim 8, wherein the battery status comprises the battery level and the drain rate of the battery in the mobile unit.

10. A base station in accordance with claim 8, wherein the additional characteristics comprise a required transmitting power.

11. A base station in accordance with claim 8, wherein the additional characteristics comprise a signal-to-noise ratio.

12. A base station in accordance with claim 8, wherein the additional characteristics comprise smart charging.

13. A mobile unit comprising:
a battery for providing power to the mobile unit;
a receiver for receiving a request report message and an instruction message from a base station, the instruction message including an LTE-U flag and a WiFi flag;
a processor for determining a current battery level and a drain rate for the battery; and
a transmitter for sending a battery measurement message to the base station in response to the request report message, the battery measurement message including the current battery level and the drain rate.

14. A mobile unit in accordance with claim 13, wherein the receiver receives an instruction message from the base station.

15. A mobile unit in accordance with claim 14, wherein the instruction message includes a flag for instructing the mobile unit to enable radio service.

16. A mobile unit in accordance with claim 15, wherein the radio service is LTE-U radio service.

17. A mobile unit in accordance with claim 15, wherein the radio service is WiFi radio service.

18. A mobile unit in accordance with claim 14, wherein the instruction message includes a flag for instructing the mobile unit to disable radio service.

19. A mobile unit in accordance with claim 18, wherein the radio service is LTE-U radio service.

20. A mobile unit in accordance with claim 18, wherein the radio service is WiFi radio service.
